(19) United States
(12) Patent Application Publication
(10) Pub. No.: US 2006/0201821 A1
(43) Pub. Date: Sep. 14, 2006

(54) Method for forming electrodeposited coating

(76) Inventors: Teruzo Toi, Neyagawa-shi (JP); Yoshio Kojima, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/372,048

(22) Filed: Mar. 10, 2006

(30) Foreign Application Priority Data
Mar. 14, 2005 (JP) 2005-071368

(51) Int. Cl. C25D 9/00; C08G 18/08

(52) U.S. Cl. 205/316; 524/589

(57) ABSTRACT

To provide a method for forming an electrodeposited coating excellent in finish-appearance and capable of a higher film resistance value. A method for forming an electrodeposited coating including a step of electrodeosition-coating a cationic electrodeposition coating composition on an object to be coated, wherein a film viscosity of an electrodeposited coating obtained from the cationic electrodeposition coating composition is in the range of 3000 to 5000 Pa·s at 50° C.

### TECHNICAL FIELD

The invention relates to a method for forming an electrodeposited coating excellent in finish appearance.

### BACKGROUND OF THE INVENTION

Cationic electrodeposition coating is a coating method in which an object to be coated is immersed in a cationic electrodeposition coating composition as a cathode and a voltage is applied thereto. Since this method can not only coat details of an object to be coated even if it has a complicated shape but also coat automatically and continuously, the method has been put into practice in many applications as an under-coating applying method for objects to be coated having a large sized, complicated shape, especially an automobile body.

Deposition of a coating in the course of cationic electrodeposition coating is caused by an electrochemical reaction and a coating is deposited by application of a voltage on a surface of an object to be coated. Since a deposited coating has an insulating property, with increase of a deposited film thickness in progress of deposition of a coating in a coating course, electrical resistivity of the coating increases. As a result, a deposition rate of a coating at a site where the coating has been deposited is lowered and instead, deposition of a coating gets started at an undeposited site. In such a way, solid component of the paint is deposited sequentially on the object to be coated to thereby eventually reach complete coating. In the specification, the nature that a coating is sequentially formed at undeposited sites of an object to be coated is referred to as “throwing power”.

In such a way, an uncured electrodeposited coating is formed. Thus obtained coating is rinsed with water to remove paint in excess remaining on the coating. It is then thermally baked to form a cured electrodeposited coating.

A method has been exemplified in which a viscosity and viscous property of a paint are adjusted, in order to prevent occurrence of sagging after coating when paint is spray-coated. For example, description is given, for example, in JP 11-166139 A, of a viscosity control agent for a paint capable of not only realizing a good pseudo plastic flow in an organic solvent base paint but also recovering a viscosity of a paint quickly enough to an extent at which a good anti-sag property is exerted after a high shearing force acts on the paint.

JP 2001-232275 discloses a film forming method in which a thermosetting organic solvent borne paint (A) containing a neutralized hydroxy-containing resin having acid value of 5 to 100 mgKOH/g and a crosslinking agent and adjusting a viscosity of coating to 1 Pa·s (20° C.) or more is coated on a surface to be coated, a thermosetting aqueous paint (B) containing a color pigment and a luster pigment is coated thereon, and then, a clear paint (C) is coated thereon (claim 1 of JP 2001-232275). This patent also explains that a coated film can be formed without sagging or the like even in an atmosphere at a low temperature and high humidity in the film forming method disclosed therein. The method, however, is greatly different from the invention in the aspects that a base paint (A) having a controlled viscosity of coating is applied by atomizing such as a spray and that a thermosetting aqueous paint (B) is spray-coated in a specific way while the base paint (A) is still in the predetermined viscosity range.

JP 2002-285077 discloses an electrodeposition coating composition for electric cable wherein a minimum film viscosity in the curing stage of the electrodeposition coating composition for an electric cable is within the range of from 30 to 150 Pa·s. In this patent, description is given of possible improvement on flowability in a molten state, edge coverage, oil repellency and the like by adjusting the minimum film viscosity in a curing stage. On the other hand, the invention of the present application is different from the invention described in the JP patent in an aspect that the invention of the present application does not adjust a viscosity in a curing stage, which is described in JP 2002-285077, but in the invention of the application, an object thereof is that a viscosity is adjusted at a deposition stage. In the drying and curing stage described in JP-2002-285077, a coating is heated at a temperature of from 100 to 250° C. and a film viscosity is measured under the drying condition. On the other hand, in the present invention, a film viscosity is measured at 50° C. The film viscosity in the drying and curing at a temperature of 100° C. or higher receives a great influence in the curing stage such as cross-linkage. On the other hand, a film viscosity at 50° C. receives a great influence from an organic solvent contained in a coating composition, Tg of resin contained, content of inorganic component and the like, a viscous behavior of which is different from that of the curing stage. In such a way, the viscous behavior of film viscosity in the curing stage is governed by factors different from those in the viscous behavior of film viscosity at 50° C. Therefore, an uncured electrodeposited coating cannot be smoothed more by using a method for controlling a viscous behavior in the curing stage. With adjustment of a viscosity at a deposition stage as done in the invention of the application applied, a release performance of hydrogen gas in an electrodeposited coating in electrodeposition coating formation can be improved, thereby enabling a surface of the electrodeposited coating to be smoothed.

### DISCLOSURE OF THE INVENTION

The invention intends to apply a technical concept that a viscous control of an uncured coating is effected after coating to an electrodeposited coating with a purpose to improve coatability of an aqueous paint. It is an object of the invention to provide a method for forming an electrodeposited coating excellent in finish appearance and capable of a higher film resistance value.

The invention is to provide a method for forming an electrodeposited coating including a step of electrodeosition-coating a cationic electrodeposition coating composition on an object to be coated, wherein a film viscosity of an electrodeposited coating obtained from the cationic electrodeposition coating composition is in the range of 3000 to 5000 Pa·s at 50° C., by means of which the object can be achieved.

In the method, a film resistance of the electrodeposited coating with a thickness of 15 μm, obtained from the cationic electrodeposition coating composition, is in the range of from 1000 to 1600 kΩ/cm².

The cationic electrodeposition coating composition is preferably an electrodeposition coating composition containing a cationic epoxy resin and a blocked isocyanate curing agent.

The invention also provides a method for an electrodeposited coating excellent in appearance, obtained by electrodeposition coating using a cationic electrodeposition coating composition with a film viscosity of an electrodeposited coating obtained from the cationic electrodeposition coating composition in the range of from 3000 to 5000 Pa·s at 500° C.

The invention also provides a method for measuring a film viscosity of an electrodeposited coating comprising: a step of forming the electrodeposited coating with a thickness of 15 μm, and a step of measuring a film viscosity of the obtained electrodeposited coating at a measurement temperature of 50° C. with a dynamic viscoelasticity measuring instrument.

Note that in the present invention, an uncured electrodeposited coating prior to baking to cure is referred to as an “electrodeposited coating” and the coating after baking is referred to as a “cured electrodeposited coating.”

With the invention applied, a method corresponding to adjustment of a viscosity and a viscous property in a solvent type paint coated by spray or the like has also been found in electrodeposition coating. By setting a film viscosity of an electrodeposition coating in the predetermined range, an electrodeposited coating can be formed with excellent finish appearance and high film resistance.

### BRIEF DESCRIPTION OF DRAWINGS

FIG. 1 shows a graph of the evaluation results described in Table 1. “ [symbol] ” indicates a Ra value of an uncured electrodeposited coating and “▴” indicates a film resistance value FR.

### DETAILED DESCRIPTION OF THE INVENTION

Cationic Electrodeposition Coating Composition

A cationic electrodeposition coating composition used in the invention contains an aqueous medium, a binder resin containing a cationic epoxy resin and a blocked isocyanate curing agent dispersed or dissolved in the aqueous medium, a neutralizing acid and an organic solvent. The cationic electrodeposition coating composition may further contain a pigment.

Cationic Epoxy Resin

A cationic epoxy resin used in the invention contains an amine-modified epoxy resin. A cationic epoxy resin is typically produced in a procedure in which all of epoxy rings of a bisphenol type epoxy resin is ring-opened with an active hydrogen compound capable of introducing a cationic group, or alternatively, in a procedure in which part of epoxy rings is ring-opened with another kind of an active hydrogen compound and the residual epoxy rings is ring-opened with an active hydrogen compound capable of introducing a cationic group.

A typical example of the bisphenol type epoxy resin is a bisphenol A type epoxy resin or a bisphenol F type epoxy resin. As commercially available products of the former, there are exemplified EPICOAT 828 (manufactured by Yuka Shell Epoxy K.K. with an epoxy equivalent in the range of from 180 to 190), EPICOAT 1001 (manufactured by Yuka Shell Epoxy K.K. with an epoxy equivalent in the range of from 450 to 500) and EPICOAT 1010 (manufactured by Yuka Shell Epoxy K.K. with an epoxy equivalent in the range of from 3000 to 4000), and as a commercially available product of the latter, there is exemplified EPICOAT 807 (manufactured by Yuka Shell Epoxy K.K. with an epoxy equivalent of 170).

An oxazolidone ring containing resin may be used as a cationic epoxy resin expressed by the following formula, described in JP 5-306327 A: 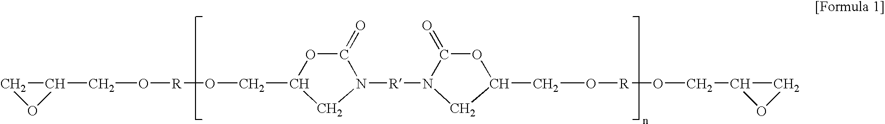
wherein R indicates a residue of diglycidyl epoxy compound, remaining after removing a glycidyloxy group therefrom, R′ is a residue of a diisocyanate compound, remaining after removing an isocyanate group therefrom and n is a positive integer. The oxazolidone ring containing resin can provide a coating with excellent heat resistance and excellent corrosion resistance.

A method for introducing an oxazolidone ring into an epoxy resin is such that, for example, a blocked isocyanate curing agent blocked with a low-grade alcohol such as methanol, and a polyepoxide are heated in the presence of a basic catalyst and a by-produced low-grade alcohol is distilled off outside the system.

An especially preferable epoxy resin is an oxazolidone ring containing epoxy resin. This is because a coating can be obtained that is excellent in heat resistance and corrosion resistance, and in addition thereto, excellent in impact resistance.

It is known that a reaction of a bifunctional epoxy resin with diisocyanate blocked with monoalcohol (that is bis-urethane) produces an epoxy resin containing oxazolidone rings. Description is given, for example in paragraphs from 0012 to 0047 of JP 2000-128959 A, of concrete examples of the oxazolidone ring-containing epoxy resin and a method for producing an oxazolidone ring-containing epoxy resin.

The epoxy resins may be modified with a suitable resin, such as polyester polyol, polyether polyol or a resin obtained from a monofunctional alkylphenol. An epoxy resin can be chain-extended by using a reaction of an epoxy group with a diol or a dicarboxyl acid.

Rings of an epoxy resin described above is desirably ring-opened with an active hydrogen compound so that an amine equivalent takes a value in the range of from 0.3 to 4.0 meq/g after ring opening and a primary amino group of the amino equivalent is more preferably in the range of 5 to 50%.

Active hydrogen compounds each of which can introduce a cationic group includes: a primary amine, a secondary amine and acid salts of a tertiary amine; a sulfide and a mixed acid. A primary amine, a secondary amine or/and a tertiary amine containing epoxy resin is prepared by using a primary amine, a secondary amine or an acid salt of a tertiary amine as an active hydrogen compound that can introduce a cationic group.

Concrete examples thereof include: butylamine, octylamine, diethylamine, dibutylamine, methylbutylamine, monoethanolamine, diethanolamine, N-methylethanolamine, triethylamine hydrochloric acid salt, N,N-dimethylethanolamine acetatic acid salt, a diethyldisulfide-acetic acid mixture; and secondary amines obtained by blocking a primary amine, such as ketimine of aminoethylethanolamine or diketimine of diethylenetriamine and the like. The amines may also be used in combination of plural kinds thereof.

Blocked Isocyanate Curing Agent

A polyisocyanate used in the invention as a blocked isocyanate curing agent is a compound having two or more isocyanate groups in a molecule. A polycyanate may be any of, for example, an aliphatic type, an alicyclic type, aromatic type and an aromatic-aliphatic type

Concrete examples of the polyisocyanate include: aromatic diisocyanates such as tolylene diisocyanate (TDI), diphenylmethane diisocyanate, p-phenylene diisocyanate and naphthalene diisocyanate; aliphatic diisocyanates each having 3 to 12 carbon atoms such as hexamethylene diisocyanate (HDI), 2,2,4-trimethylhexane diisocyanate and lysine diisocyanate; alicyclic diisocyanates each having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate, 1,3-diisocyanatomethylcyclohexane (hydrogenated XDI), hydrogenated TDI, 2,5-or 2,6-bis(isocyanatomethyl)-bicyclo[2.2.1]heptane (also referred to as norbornane diisocyanate); aliphatic diisocyantes each having an aromatic ring such as xylylene diisocyanate (XDI) and tetramethylxylylene diisocyanate (TMXDI); modified compounds of the diisocyanates (a urethanized compound, a carbodiimide, urethodione, urethoimine and burette and/or isocyanurate modified compounds). The polycyanates can be used either alone or in combination of two or more kinds.

Blocked isocyanate curing agents may include an adduct or a prepolymer obtained by reacting a polyhydroxy alcohol such as ethylene glycol, propylene glycol, trimethylolpropane or hexanetriol with a polyisocyanate at a ratio NCO/OH of 2 or more.

A blocking agent works in a way such that the agent is added to a polyisocyanate group, which adduct is stable at ordinary temperature, but can reproduce a free isocyanate group when being heated at a dissociation temperature or higher.

Blocking agents which are usually used include, for example, ε-caprolactam, butyl cellosolve and the like.

Pigments

An electrodeposition coating composition used in the invention may contain a pigment that is ordinarily used. Examples of such a pigment include: inorganic pigments that are usually used, including colorant pigments such as titanium white, carbon black and red iron oxide; extender pigments such as kaolin, talc, aluminum silicate, calcium carbonate, mica and clay; and rust preventive pigments such as zinc phosphate, iron phosphate, aluminum phosphate, calcium phosphate, zinc phosphite, zinc cyanate, zinc oxide, aluminum tripolyphosphate, zinc molybdate, aluminum molybdate, calcium molybdate, aluminum phosphomolybdate and aluminum zinc phosphomolybdate.

Such a pigment can be contained at a concentration in the range of from 0 to 40 wt % and preferably in the range of from 0 to 30 wt % relative to a solid content in a cationic electrodeposition coating composition. If a pigment concentration falls outside the range, a possibility arises that appearance of a coating is deteriorated.

A pigment, in a case where it is used as a component of an electrodeposition coating composition, is generally dispersed into an aqueous medium at a high concentration in advance to prepare a paste (pigment dispersed slurry). This is because since a pigment is powdery, the pigment has difficulty dispersing in one step into a low concentration uniform state in which an electrodeposition coating composition is used. Such a paste is generally referred to as a pigment dispersed paste.

A pigment dispersed paste is prepared by dispersing it into an aqueous medium together with a pigment dispersant resin varnish. Pigment dispersant resins generally include: cationic polymers such as a cationic or nonionic low molecular weight surfactant and a modified epoxy resin having a quaternary ammonium group and/or a tertiary sulfonium group. Aqueous media include: ion exchanged water and water containing a small quantity of alcohol.

A pigment dispersant resin is generally used in the range of from 20 to 100 parts by mass as a solid content relative to 100 parts by mass of a pigment. A pigment dispersant resin varnish and a pigment are mixed together and thereafter, the pigment is dispersed with an ordinary dispersing apparatus such as a ball mill or a sand grind mill till particle diameters of the pigment in the mixture assume predetermined uniform particle diameters to thereby obtain a pigment dispersed paste.

A cationic electrodeposition coating composition used in the invention may contain, in addition to the components, organotin compound such as dibutyltin dilaurate, dibutyltinoxide, dioctyltinoxide and the like; and amines such as N-methylmorphorine and the like; salts of metals such as strontium, cobalt, copper and the like as a catalyst. The compounds each can act as a catalyst for dissociation of a blocking agent in a curing agent. A concentration of a catalyst is preferably in the range of from 0.1 to 6 parts by mass relative to 100 parts by mass of a total of a cationic epoxy resin and a curing agent in an electrodeposition coating composition.

Preparation of Cationic Electrodeposition Coating composition A cationic electrodeposition coating composition of the invention can be prepared by dispersing a cationic epoxy resin described above, a blocked isocyanate curing agent, and, if necessary, a pigment dispersed paste and a catalyst into an aqueous medium. Usually, the aqueous medium contains a neutralizing acid in order to neutralize a cationic epoxy resin to thereby increase dispersibility. Examples of the neutralizing acid include: inorganic acids and organic acids such as hydrochloric acid, nitric acid, phosphoric acid, formic acid, acetic acid, lactic acid, sulfamic acid and acetyl glycine. An aqueous medium in the specification is water or a mixture of water and an organic solvent. Ion exchanged water is preferably used as water. Examples of organic compounds that can be used include: hydrocarbons such as xylene and toluene; alcohols such as methyl alcohol, n-butyl alcohol, isopropyl alcohol, 2-ethylhexyl alcohol, ethylene glycol and propylene glycol; ethers such as ethylene glycol monoethyl ether, ethylene glycol monobutyl ether, ethylene glycol monohexyl ether, propylene glycol monoethyl ether, 3-methyl-3-methoxybutanol, diethylene glycol monoethyl ether and diethylene glycol monobutyl ether; ketones such as MIBK, cyclohexanone, isophorone and acetyl acetone; esters such as ethylene glycol monoethyl ether acetate and ethylene glycol monobutyl ether acetate; and mixtures thereof.

A quantity of a blocked isocyanate curing agent has to be enough to react with an active hydrogen containing functional group such as a primary amino group, a secondary amino group and a hydroxyl group in a cationic epoxy resin during curing to thereby give a good cured coating and a ratio in weight of a solid content of a cationic epoxy resin to a blocked isocyanate curing agent (epoxy resin/curing agent) is generally in the range of from 90/10 to 50/50 and preferably in the range of from 80/20 to 65/35. A neutralizing acid is a quantity enough to neutralize at least 20% of a cationic group of a cationic epoxy resin and preferably a quantity enough to neutralize a cationic group of a cationic epoxy resin in the range of from 30 to 60% thereof.

An organic solvent is indispensably necessary as a solvent in preparing a resin component such as a cationic epoxy resin, a blocked isocyanate curing agent and the like and a necessity arises for a complicated operation to be applied for removing the solvent perfectly. With an organic solvent contained in a binder resin adopted, a fluidity of a coating during film formation is increased to thereby improve smoothness of the coating.

Examples of organic solvents that are usually contained in a coating composition include: ethylene glycol monobutyl ether, ethylene glycol monohexyl ether, ethylene glycol monoethyl hexyl ether, propylene glycol monobutyl ether, dipropylene glycol monobutyl ether, propylene glycol monophenyl ether and the like.

A cationic electrodeposition coating composition can contain, in addition to the components described above, agents commonly used such as a plasticizer, a surfactant, an antioxydant and an ultraviolet absorbent.

Method for Coating Cationic Electrodeposition Coating Composition

The cationic electrodeposition coating composition is electrodeposition-coated on an object to be coated to thereby form an electrodeposited coating. No specific limitation is placed on an object to be coated and any of conductive objects can be used; examples thereof include: an iron plate, a steel plate and an aluminum plate; the surface-treated plates; and formed products thereof.

Electrodeposition of a cationic electrodeposition coating composition is performed by applying a voltage usually in the range of from 50 to 450 V between an object to be coated as a cathode and an anode. If an applied voltage is less than 50 V, electrodeposition is insufficient, while if an applied voltage exceeds 450 V, a coating is broken to show abnormal appearance. During electrodeposition, a temperature of a bath liquid of a coating composition is usually adjusted at a temperature in the range of from 10 to 45° C.

An electrodeposition process is constituted of a step of immersing an object to be coated into a cationic electrodeposition coating composition and a step of applying a voltage between the object to be coated as a cathode and an anode to thereby deposit a coating. A time during which a voltage is applied is different according to conditions for electrodeposition but generally can be in the range of 2 to 4 min.

A cationic electrodepostion coating composition used in a method of the invention is characterized by that a film viscosity at 50° C. of an electrodeposited coating obtained from the cationic electrodeposition coating composition is designed so as to be in the range of from 3000 to 5000 Pa·s.

An electrodeposited coating is a coating deposited on a surface of the object to be coated by application of a voltage. An electrodeposited coating is generally designed so as to secure a higher viscosity (high Tg) as compared with a finish coating composition and a second coating composition in order to achieve corrosion resistance. Hence, a viscosity of an electrodeposited coating measured at a temperature of a general electrodeposition bath (for example, 30° C.) is very high, which sometimes brings about even a case where measurement of a viscosity cannot be effected. Therefore, it is very difficult to measure a film viscosity of an electrodeposited coating at 30° C., which is one factor of conditions for electrodeposition coating. On the other hand, in the electrodeposited coating, a heat flow is created by heating and a viscosity is lowered to thereby smooth a surface of the coating. By further heating, a blocking agent of a blocked isocyanate curing agent contained in the electrodeposited coating is thermally dissociated, which is subjected to a crosslinking reaction with a hydroxyl group or an amino group in a cationic epoxy resin to thereby raise a film viscosity rapidly. Thereby, the electrodeposited coating is cured to form a cured elelctrodeposited coating. That is, an electrodeposited coating is heated to thereby decrease a viscosity once, followed by increase in viscosity.

During electrodeposition coating, a Joule heat is generated to thereby raise a temperature in the vicinity of an object to be coated to a value of the order in the range of from 40 to 50° C. The inventor has found through experiments, conducted based on the phenomenon, the fact that in a case where a film viscosity of electrodeposition coating is measured at 50° C., a correlation of a film viscosity with a coating appearance of an electrodeposited coating and a correlation of a film viscosity with a throwing power property are the highest. A temperature of 50° C. is thought to be a temperature at which a film viscosity is preferably measured from the reason described above, and at which no crosslikage of a binder resin occurs either.

Various methods in which a film viscosity at 50° C. of electrodeposited coating obtained from a cationic electrodeposition coating composition is in the range of from 3000 to 5000 Pa·s are available: for example, a method in which a molecular weight and Tg of a cationic epoxy resin contained in an electrodeposition coating composition is adjusted, a method in which a blocking agent of a blocked isocyanate curing agent is selected, a method in which a mixing ratio of a cationic epoxy resin to a blocked isocyanate curing agent is adjusted, a method in which a content of a pigment is adjusted and a method in which a quantity of a solvent contained in an electrodeposition coating composition is adjusted.

Note that a film viscosity of-an electrodeposited coating can be measured in the following way: First of all, an electrodeposited coating is formed on an object to be coated so as to obtain a film thickness of about 15 μm and the coating is rinsed with water to thereby remove an electrodeposition coating composition in excess. Then, unnecessary water attached on a surface of the object to be coated is removed, and immediately thereafter, the coating is taken out without drying to prepare a sample. Thus obtained sample can be subjected to measurement of a film viscosity at 50° C. with a dynamic viscoelasticity measuring instrument.

A film thickness of an electrodeposited coating can be generally in the range of from 5 to 25 μm. If a film thickness is less than 5 μm, there arises a possibility of insufficient rust prevention. A film resistance of an electrodeposited coating with a film thickness of 15 μm is preferably in the range of from 1,000 to 1,600 kΩ/cm². If a film resistance of a coating is less than 1,000 kΩ/cm², sufficient electrical resistance is not obtained, leading to a poor throwing power property, while if a film resistance thereof exceeds 1,600 kΩ/cm², it results in degraded coating appearance. A film resistance of a coating is more preferably in the range of from 1,100 to 1,500 kΩ/cm².

The film resistance value of a coating is obtained using the following equation from a residual current value (A) at a final electrodeposition voltage (V):
Film resistance value (FR)=V/A (Equation 1)

Thus obtained electrodeposited coating is, after electrodeposition is over, as it is or rinsed with water, thermally set at a temperature in the range of from 120 to 260° C. and preferably in the range of from 140 to 220° C. for a time in the range of from 10 to 30 min to thereby harden the coating to thereby obtain a cured electrodeposited coating.

### EXAMPLES

Detailed description will be further given of the invention with-examples described below, to which the invention is not limited. Note that the term “part or parts” is expressed based on weight unless specified otherwise.

### Production Example 1-1

### Production of Blocked Isocyanate Curing Agent

199 parts of a trimer of hexamethylene diisocyanate (manufactured by Nihon Polyurethane Industry Co., Ltd. with a trade name of COLONATE HX), 32 parts of methyl isobutyl ketone (MIBK) and 0.03 parts of dibutyltin dilaurate were weighted into a flask to which an agitator, a cooler, a nitrogen injection tube, a thermometer and a dropping funnel were mounted and 87.0 parts of methyl ethyl ketoxime was dropped into the mixture from the dropping funnel over 1 hr while agitated and bubbled with nitrogen. A temperature was raised from 50° C. to 70° C. Thereafter, a reaction was continued for 1 hr until an absorption of NCO group in infrared spectrometer became disappeared. Thereafter, 0.74 part of n-butanol and 39.93 parts of MIBK were added and a non-volatile content was adjusted to 80%.

### Production Example 1-2

### Production of Blocked Isocyanate Curing Agent

125 parts of diphenylmethane diisocyanate and 26.6 parts of MIBK were weighted into a flask to which an agitator, a cooler, a nitrogen injection tube, a thermometer and a dropping funnel were mounted and after the mixture was heated up to 80° C., 0.25 part of dibutyltin dilaurate was added. A solution obtained by dissolving 22.6 parts of ε-caprolactam into 94.4 parts of butyl cellosolve was dropped into the mixture from the dropping funnel over 2 hr at 80° C. After the mixture was further heated at 100° C. for 4 hr, a reaction was continued until an absorption of NCO group in infrared spectrometer became disappeared. After being left and cooled, 33.6 parts of MIBK was added and a non-volatile content was adjusted to 80%.

### Production Example 2

### Production of Amine-Modified-Epoxy Resin Emulsion

71.34 parts of 2,4/2,6-tolylene diisocyanate (80/20 wt %), 111.98 parts of MIBK and 0.02 part of dibutyltin dilaurate were weighed into a flask to which an agitator, a cooler, a nitrogen injection tube, a thermometer and a dropping funnel were mounted and 14.24 parts of methanol was dropped into the mixture from the dropping funnel over 30 min while agitated and bubbled with nitrogen. A temperature was raised from room temperature up to 60° C. by exothermic heat. Thereafter, the reaction was continued for 30 min and then, 46.98 parts of ethylene glycol mono-2-ethyl hexyl ether was dropped over 30 min from the dropping funnel. The mixture was heated up to a temperature in the range of from 70 to 75° C. by exothermic heat. After the reaction was continued for 30 min, 41.25 parts of bisphenol A propylene oxide (5 mol) adduct (manufactured by Sanyo Kasei Kogyo K.K. with a trade name of BP-5P) was added and the mixture was heated up to 90° C. and the reaction was continued till absorption caused by an NCO group disappeared while an IR spectrum is measured.

Subsequent thereto, 475.0 parts of bisphenol A type epoxy resin with an epoxy equivalent of 475 (manufactured by Toto Kasei K. K. with a trade name of YD-7011R) was added and dissolved to uniformity, followed by raising a temperature from 130° C. up to 142° C. to thereby remove water from the reaction system by azeotropy with MIBK. After being cooled down to 125° C., 1.107 parts of benzyl dimethyl amine was added to thereby cause an oxazolidone ring forming reaction by demethanolization until an epoxy equivalent was 1140.

Thereafter, the reaction mixture was cooled down to 100° C., into which 24.56 parts of N-methylethanolamine, 11.46 parts of diethanolamine and 26.08 parts of aminoethylethanolamine ketimine (78.8% MIBK solution) were added and a reaction in the mixture was caused at 110° C. for 2 hr. Thereafter, 20.74 parts of ethylene glycol mono-2-ethylhexyl ether and 12.85 parts of MIBK were added for dilution to thereby adjust a non-volatile content to 82%. A number-average molecular weight (with GPC method) was 1380 and an amine equivalent was 94.5 meq/100 g.

145.11 parts of ion exchanged water and 5.04 parts of acetic acid were weighed into a different vessel, into which a mixture of 320.11 parts of the amine-modified epoxy resin at 70° C. (75.0 parts as a solid content) and 190.38 parts (25.0 parts as a solid content) of the blocked isocyanate curing agent of Production Example 1 were slowly dropped and agitated to thereby obtain a uniform dispersion. Thereafter, ion exchanged water was added to adjust a solid content to 36%.

### Production Example 3

### Production of Pigment Dispersant Resin Varnish

382.20 parts of a bisphenol A type epoxy resin with an epoxy equivalent of 188 (with a trade name of DER-331J from Dow Chemical Company) and 111.98 parts of bisphenol A were weighted into a flask to which an agitator, a cooler, a nitrogen injection tube, a thermometer and a dropping funnel were mounted and the mixture is heated up to 80° C. and dissolved to uniformity, thereafter. 1.53 parts of a 1% solution of 2-ethyl-4-methylimidazole was added to thereby cause a reaction at 170° C. for 2 hr. After the mixture was cooled down to 140° C., 196.50 parts of 2-ethylhexanol half-blocked isophorone diisocyanate (with a non-volatile content of 90%) was added thereinto and a reaction was continued till an NCO group disappeared. 205.0 parts of dipropylene glycol monobutyl ether was added into the mixture and subsequent thereto, 408.0 parts of 1-(2-hydroxyethylthio)-2-propanol and 134.00 parts of dimethylol propionic acid were further added into the mixture, and 144.0 parts of ion exchanged water was further added and the reaction was effected at 70° C. The reaction was continued till an acid value was reduced to 5 or less. The obtained resin varnish was diluted with 1150.5 parts of ion exchanged water so that a non-volatile content was 35%.

### Production Example 4

### Production of Pigment Dispersed Paste

120 parts of the pigment dispersant resin varnish obtained in Production Example 3, 2.0 parts of carbon black, 100.0 parts of kaolin, 72.0 parts of titanium dioxide, 8.0 parts of dibutyltin oxide, 18.0 parts of aluminum phosphomolybdate and 184 parts of ion exchanged water were put into a sand grind mill to grind it into grain sizes of 10 μm or less and to obtain a pigment dispersed paste (a non-volatile content of 48%).

### Example 1

### Preparation of Cationic Electrodeposition Coating Composition

The amine-modified epoxy resin obtained in Production Example 2 and the blocked isocyanate curing agent obtained in Production Example 1-1 were mixed to uniformity so as to be at a ratio in solid content therebetween of 80/20. Glacial acetic acid was added to the mixture so that a mg equivalent (MEQ(A)) of an acid per 100 g of a resin solid content was 30 and ion exchanged water was further added slowly to the mixture for dilution. MIBK was removed under a reduced pressure to thereby obtain an emulsion with a solid content of 36%.

2444.4 parts of the above emulsion, 250 parts of the pigment dispersed paste obtained in Production Example 4, 2345.6 parts of ion exchanged water and 10 parts of dibutyltin oxide were mixed together to thereby obtain a cationic electrodeposition coating composition having a solid content of 20 wt %.

The above obtained cationic electrodeposition coating composition was evaluated according the following method.

Measurement of Film viscosity of Electrodeposited Coating An electrodeposited coating was formed on an object to be coated to a film thickness of 15 am and the coating was rinsed with water to remove the electrodeposition coating composition in excess. Then, water was removed and immediately thereafter, the coating material was removed from the coated panel without drying to prepare a sample. The obtained sample was subjected to measurement of a frequency dependency of dynamic viscoelasticity with Rheosol-G-3000, which is a rotary type dynamic viscoelasticity measuring instrument, (manufactured by K.K. U B M), in set conditions that a strain was 0.5 deg and a frequency was 0.02 Hz. The prepared sample was set and a measurement temperature was kept at 50° C. After the start of measurement, a viscosity of a coating was measured when an electrodeposited coating was spread uniformly in a conic plate.

Appearance Evaluation of Electrodeposited Coating

Appearance evaluation of an electrodeposited coating was based on measurement of an arithmetic average deviation from the center (or a center-line mean roughness) of a surface profile curve (a roughness curve)(Ra). An uncured electrodeposited coating obtained from an electrodeposition coating composition was left as it was at 20° C. for 3 hr. Thereafter, an Ra value of the uncured electrodeposited coating was measured with an evaluation type surface roughness measuring instrument (manufactured by Mitsutoyo K.K. with a trade name of SURFTEST SJ-201P) according to JIS B0601. Measurement was conducted seven times with a 2.5 mm cut-off in 5 intervals on a sample, wherein the average was obtained excluding the maximum value and the minimum value. In Table 1, there are shown results. A smaller Ra value means that profile peaks and valleys are less, resulting in better coating appearance.

Film Resistance

A coating with a thickness of 15 μm was electrodeposited at a bath temperature of 30° C. An electrodeposition voltage and a residual current, when electrodeposition was over, were measured, from which a film resistance value (kΩ/cm²) was calculated (by Equation 1).

### Example 2

### Preparation of Cationic Electrodeposition Coating Composition

The amine-modified epoxy resin obtained in Production Example 2 and the blocked diisocyanate curing agent obtained in Production Example 1-1 were mixed together to uniformity so as to adjust a solid content ratio therebetween to 70/30. Glacial acetic acid was added into the mixture so that a mg equivalent of an acid per 100 g of a solid content (MEQ (A)) was 30 and ion exchanged water was slowly added thereinto. MIBK was removed under a reduced pressure to obtain an emulsion with a solid content of 36%.

2444.4 parts of the emulsion, 250 parts of the pigment dispersed paste obtained in Production Example 4, 2345.6 parts of ion exchanged water and 10 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Example 3

### Preparation of Cationic Electrodeposition Coating Composition

The amine-modified epoxy resin obtained in Production Example 2 and the blocked diisocyanate curing agent obtained in Production Example 1-2 were mixed together to uniformity so as to adjust a solid content ratio therebetween to 80/20. Glacial acetic acid was added into the mixture so that a mg equivalent of an acid per 100 g of a solid content (MEQ (A)) was 30 and ion exchanged water was slowly added thereinto. MIBK was removed under a reduced pressure to obtain an emulsion with a solid content of 36%.

2444.4 parts of the emulsion, 250 parts of the pigment dispersed paste obtained in Production Example 4, 2345.6 parts of ion exchanged water and 10 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Example 4

### Preparation of Cationic Electrodeposition Coating Composition

The amine-modified epoxy resin obtained in Production Example 2 and the blocked diisocyanate curing agent obtained in Production Example 1-2 were mixed together to uniformity so as to adjust a solid content ratio therebetween to 70/30. Glacial acetic acid was added to the mixture so that a mg equivalent of an acid per 100 g of a solid content (MEQ (A)) was 30, and ion exchanged water was slowly added for dilution. MIBK was removed under a reduced pressure to obtain an emulsion with a solid content of 36%.

2444.4 parts of the emulsion, 250 parts of the pigment dispersed paste obtained in Production Example 4, 2345.6 parts of ion exchanged water and 10 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Comparative Example 1

### Preparation of Cationic Electrodeposition Coating Composition

The amine-modified epoxy resin obtained in Production Example 2 and the blocked diisocyanate curing agent obtained in Production Example 1-2 were mixed together to uniformity so as to adjust a solid content ratio therebetween to 80/20. Glacial acetic acid was added into the mixture so that a mg equivalent of an acid per 100 g of a solid content (MEQ (A)) was 30, and ion exchanged water was slowly added thereinto. MIBK was removed under a reduced pressure to obtain an emulsion with a solid content of 36%.

2231.8 parts of the emulsion, 417 parts of the pigment dispersed paste obtained in Production Example 4, 2394.8 parts of ion exchanged water and 6.4 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Comparative Example 2

### Preparation of Cationic Electrodeposition Composition

The amine-modified epoxy resin obtained in Production Example 2 and the blocked diisocyanate curing agent obtained in Production Example 1-2 were mixed together to uniformity so as to adjust a solid content ratio therebetween to 80/20. Glacial acetic acid was added into the mixture so that a mg equivalent of an acid per 100 g of a solid content (MEQ (A)) was 30, and ion exchanged water was slowly added thereinto. MIBK was removed under a reduced pressure to obtain an emulsion with a solid content of 36%.

2762.7 parts of the emulsion, 2271.9 parts of ion exchanged water and 15.4 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Comparative Example 3

### Preparation of Cationic Electrodeposition Coating Composition

The amine-modified epoxy resin obtained in Production Example 2 and the blocked diisocyanate curing agent obtained in Production Example 1-2 were mixed together to uniformity so as to adjust a solid content ratio therebetween to 70/30. Glacial acetic acid was added into the mixture so that a mg equivalent of an acid per 100 g of a solid content (MEQ (A)) was 30, and ion exchanged water was slowly added thereinto. MIBK was removed under a reduced pressure to obtain an emulsion with a solid content of 36%.

2444.4 parts of the emulsion, 250 parts of the pigment dispersed paste obtained in Production Example 1-2, 2335.5 parts of ion exchanged water, 10 parts of ethylene glycol monobutyl ether and 10 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

### Comparative Example 4

### Preparation of Cationic Electrodeposition Coating Composition

The amine-modified epoxy resin obtained in Production Example 2 and the blocked diisocyanate curing agent obtained in Production Example 1-1 were mixed together to uniformity so as to adjust a solid content ratio therebetween to 80/20. Glacial acetic acid was added into the mixture so that a mg equivalent of an acid per 100 g of a solid content (MEQ (A)) was 30, and ion exchanged water was slowly added thereinto. MIBK was removed under a reduced pressure to obtain an emulsion with a solid content of 36%.

2762.7 parts of the emulsion, 2261.9 parts of ion exchanged water, 10 parts of ethylene glycol monobutyl ether and 15.4 parts of dibutyltin oxide were mixed together to obtain a cationic electrodeposition coating composition with a solid content of 20 wt %.

Evaluation was conducted on the above obtained cationic electrodeposition coating composition in a similar way to that in Example 1. In Table 1, there are shown results of the evaluation.

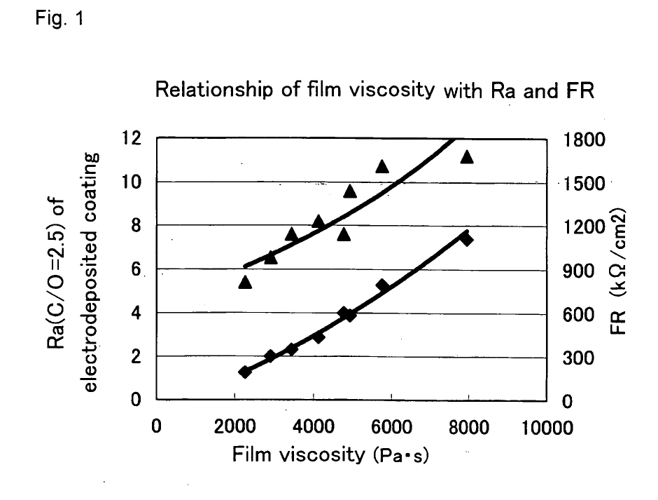

In FIG. 1, there is shown a graph of the evaluation results shown in Table 1. In FIG. 1, “ [symbol] ” indicates a Ra value of an uncured electrodeposited coating and “▴” indicates a film resistance value FR.

TABLE 1

| | Example | Example | Example | Example | Comparative | Comparative | Comparative | Comparative |
|---|---|---|---|---|---|---|---|---|
| | 1 | 2 | 3 | 4 | Example 1 | Example 2 | Example 3 | Example 4 |
| Film viscosity of | 4921 | 4764 | 4117 | 3440 | 7954 | 5747 | 2249 | 2900 |
| electro-deposited | | | | | | | | |
| coating | | | | | | | | |
| Ra (with cut-off = | 3.88 | 4.00 | 2.88 | 2.32 | 7.38 | 5.28 | 1.26 | 2.01 |
| 2.5 mm) of | | | | | | | | |
| uncured | | | | | | | | |
| electro-deposited | | | | | | | | |
| coating | | | | | | | | |
| Film resistance | 1440 | 1140 | 1230 | 1140 | 1680 | 1610 | 810 | 980 |
| value FR, 4: | | | | | | | | |
| Example 1, 5: | | | | | | | | |
| Comp. Ex. 1 | | | | | | | | |

An electrodeposition paint deposition used in a cationic electrodeposition coating, as clear from the results of the examples and the comparative examples, can form an electrodeposited coating excellent in appearance and high in film resistance value by setting a film viscosity of an electrodeposited coating so as to be in the range of from 3000 to 5000 Pa·s.

1. A method for forming an electrodeposited coating comprising a step electrodeposition-coating a cationic electrodeposition coating composition on an object to be coated, wherein a film viscosity of an electrodeposited coating obtained from the cationic electrodeposition coating composition is in the range of 3000 to 5000 Pa·s at 50° C.

2. The method for forming an electrodeposited coating according to claim 1, wherein a film resistance of the electrodeposited coating with a thickness of 15 μm, obtained from the cationic electrodeposition coating composition, is in the range of from 1000 to 1600 kΩ/cm².

3. The method for forming a multilayer coating according to claim 1, wherein the cationic electrodeposition coating composition is an electrodeposition coating composition containing a cationic epoxy resin and a blocked isocyanate curing agent.

4. A method for an electrodeposited coating excellent in appearance, obtained by electrodeposition coating using a cationic electrodeposition coating composition with a film viscosity of an electrodeposited coating obtained from the cationic electrodeposition coating composition in the range of from 3000 to 5000 Pa·s at 50° C.

5. A method for measuring a film viscosity of an electrodeposited coating comprising: a step of forming the electrodeposited coating with a thickness of 15 μm, and a step of measuring a film viscosity of the obtained electrodeposited coating at a measurement temperature of 50° C. with a dynamic viscoelasticity measuring instrument.

6. The method for forming a multilayer coating according to claim 2, wherein the cationic electrodeposition coating composition is an electrodeposition coating composition containing a cationic epoxy resin and a blocked isocyanate curing agent.
